(19) United States
(12) Patent Application Publication
(10) Pub. No.: US 2025/0364587 A1
(43) Pub. Date: Nov. 27, 2025

(54) ELECTROLYTIC SOLUTION AND LITHIUM-ION BATTERY

(71) Applicant: TOYOTA JIDOSHA KABUSHIKI KAISHA, Toyota-shi (JP)

(72) Inventor: Keiichi MINAMI, Tagata-gun (JP)

(73) Assignee: TOYOTA JIDOSHA KABUSHIKI KAISHA, Toyota-shi (JP)

(21) Appl. No.: 19/204,988

(22) Filed: May 12, 2025

(30) Foreign Application Priority Data
May 24, 2024 (JP) 2024-084993

(51) Int. Cl. H01M 10/056; H01M 4/02; H01M 4/134; H01M 4/38; H01M 10/0525

(52) U.S. Cl. CPC H01M 10/056; H01M 4/134; H01M 4/382; H01M 10/0525; H01M 2004/027

(57) ABSTRACT

A main object of the present disclosure is to provide an electrolytic solution having good oxidation resistance and capable of suppressing an increased battery resistivity. The present disclosure achieves the object by providing an electrolytic solution used in a lithium-ion battery, wherein the lithium-ion battery contains a lithium metal as an anode active material, the electrolytic solution contains an organic electrolytic solution and an inorganic electrolytic solution, and the inorganic electrolytic solution contains a lithium salt and sulfur dioxide (SO₂).

### TECHNICAL FIELD

The present disclosure relates to an electrolytic solution and a lithium-ion battery.

### BACKGROUND ART

In recent years, a battery has been actively developed. For example, the automotive industry is developing battery for use in battery electric vehicle (BEV), plug-in hybrid vehicles (PHEV), or hybrid vehicles (HEV). In addition, members and materials used in the battery are being developed.

For example, Patent Literature 1 discloses an organic electrolytic solution battery comprising a cathode, an anode, an organic electrolytic solution, and a separator. In Patent Literature 1, it is disclosed that the anode is made of a lithium metal, a lithium alloy, or a material capable of absorbing and desorbing lithium.

### CITATION LIST

### Patent Literature

Patent Literature 1: Japanese Patent Application Laid-Open (JP-A) No. 2010-225498 JP

### SUMMARY OF DISCLOSURE

### Technical Problem

Among electrolytic solutions, an organic electrolytic solution generally has a high upper limit value of the potential window, and has an advantage in that oxidation resistance is good. In addition, a lithium metal is useful as a material for an anode active material from the viewpoint of improving the high-energy-density of battery. On the other hand, as will be described later, when the lithium metal and the organic electrolytic solution are used, the resistivity may be increased due to a coat (a Solid Electrolyte Interphase: SEI) formed on the surface of the lithium metal.

The present disclosure has been made in view of the above circumstances, and an object of the present disclosure is to provide an electrolytic solution having good oxidation resistance and capable of suppressing an increased battery resistivity.

### Solution to Problem

[1]

An electrolytic solution used in a lithium-ion battery, wherein
the lithium-ion battery contains a lithium metal as an anode active material,
the electrolytic solution contains an organic electrolytic solution and an inorganic electrolytic solution, and
the inorganic electrolytic solution contains a lithium salt and sulfur dioxide (SO₂).
[2]

The electrolytic solution according to [1], wherein the lithium salt contains at least one of AlCl₄⁻ and BCl₄⁻ as an anionic component.
[3]

The electrolytic solution according to [1] or [2], wherein a ratio of the inorganic electrolytic solution to a total of the organic electrolytic solution and the inorganic electrolytic solution is 0.05% by weight or more and 70.0% by weight or less.
[4]

The electrolytic solution according to any one of [1] to [3], wherein a ratio of the inorganic electrolytic solution to a total of the organic electrolytic solution and the inorganic electrolytic solution is 0.10% by weight or more and 40.0% by weight or less.
[5]

A lithium-ion battery using a lithium metal as an anode active material, wherein the lithium-ion battery contains the electrolytic solution according to any one of [1] to [4].

### Advantageous Effects of Disclosure

According to the present disclosure, it is possible to provide an electrolytic solution having good oxidation resistance and capable of suppressing an increase in battery resistivity.

### BRIEF DESCRIPTION OF DRAWINGS

FIG. 1 is a schematic cross-sectional view illustrating a lithium-ion battery in the present disclosure.

FIG. 2 is a graph showing the results of the oxidation resistance evaluation of the electrolytic solution.

### DESCRIPTION OF EMBODIMENTS

Hereinafter, the electrolyte solution and the lithium-ion battery according to the present disclosure will be described in detail. Note that the drawings shown below are schematically shown, and the size and shape of each part are appropriately exaggerated for ease of understanding.

### A. Electrolyte (Electrolytic Solution)

The electrolyte used in the present disclosure is an electrolyte used in a lithium-ion battery. The lithium-ion battery contains a lithium-metal as an anode active material. The electrolyte includes an organic electrolyte and an inorganic electrolyte. The inorganic electrolyte contains a lithium-salt and sulfur dioxide (SO₂).

The electrolyte solution of the present disclosure contains a predetermined inorganic electrolyte solution in addition to the organic electrolyte solution. As a result, the electrolyte of the present disclosure has good oxidation resistance and can suppress battery resistivity from increasing.

As described above, the lithium-ion battery has an advantage in using an organic electrolyte solution and a lithium-metal. On the other hand, since the lithium metal has relatively high reaction activity, side reactions may occur with the electrolytic solution. As a consequence, there is a possibility that the organic electrolyte solution is reductively decomposed on the surface of anode active material (lithium-metal) to form a film (SEI). In this respect, it is assumed that the increased interfacial resistance of anode active material by the coating depends on the denseness (insulating property) and the thickness of the coating. When the denseness of the coating film is low, the decomposition reaction of the electrolytic solution tends to proceed, and the thickness of the coating film increases (the coating film grows). In addition, when an organic electrolyte solution is used, it is considered that the denseness of the produced coating film is low, the coating film grows thicker due to the progress of decomposition of the electrolyte solution, and the interfacial resistance of anode active material is increased. On the other hand, it is presumed that when an inorganic electrolyte solution containing sulfur dioxide (SO₂) and a lithium salt is used, the denseness of the film to be formed is high, and the progress of the decomposition reaction of the electrolyte solution can be suppressed. Even when the inorganic electrolytic solution is used together with the organic electrolytic solution, it is considered that a thin film caused by decomposition of the inorganic electrolytic solution can suppress film formation of the organic electrolytic solution and can suppress thickening of the film. As a result, the electrolyte of the present disclosure, which contains an organic electrolyte solution and a predetermined inorganic electrolyte solution, can obtain the merit (good oxidation resistance) of the organic electrolyte solution and suppress battery resistivity from increasing.

### 1. Inorganic Electrolyte

Inorganic electrolyte in the present disclosure contains lithium-salt and sulfur dioxide (SO₂).

The cationic components in the lithium-salt are typically Li⁺. Examples of the anionic components in the lithium salt include chloride anions such as AlCl₄⁻, GaCl₄⁻, BF₄⁻, BCl₄⁻ and InCl₄⁻. Of these, AlCl₄⁻ and GaCl₄⁻ are preferred. The lithium salt may contain one kind of anion component or two or more kinds thereof.

The composition of the inorganic electrolyte can be expressed as LiX-αSO₂. X is an anionic component, α is a number satisfying 0.5≤α≤10. α may be 1.0 or more, 3.0 or more, or 5.0 or more. On the other hand, α may be 8.0 or less, or 6.0 or less. Inorganic electrolytes can be made by injecting SO₂ gases into lithium-salt materials (e.g., mixtures of LiCl and AlCl₄).

The ratio (weight ratio) of the inorganic electrolytic solution to the total of the organic electrolytic solution and the inorganic electrolytic solution is not particularly limited, but is, for example, 0.05% by weight or more. The proportion of the inorganic electrolyte may be 0.1 wt % or more, may be 1.0 wt % or more, may be 5.0 wt % or more, or may be 10.0 wt % or more. On the other hand, the proportion of the inorganic electrolyte is, for example, 70.0% by weight or less. The proportion of the inorganic electrolyte may be 50.0% by weight or less, may be 40.0% by weight or less, may be 30.0% by weight or less, or may be 20.0% by weight or less.

The ratio (volume ratio) of the inorganic electrolytic solution to the total of the organic electrolytic solution and the inorganic electrolytic solution is not particularly limited, but is, for example, 0.05% by volume or more. The proportion of the inorganic electrolyte may be 0.1 volume % or more, may be 1.0 volume % or more, may be 5.0 volume % or more, 10.0 volume % or more, may be 20.0 volume % or more. On the other hand, the proportion of the inorganic electrolyte is, for example, 70.0% by volume or less. The proportion of the inorganic electrolyte may be 50.0% by volume or less, may be 40.0% by volume or less, or may be 30.0% by volume or less.

### 2. Organic Electrolyte Solution

Examples of the organic electrolytic solution in the present disclosure include an electrolytic solution containing a supporting salt and an organic solvent.

Support salts include, for example, mineral lithium salts such as LiPF₆, LiBF₄, LiClO₄ and LiAsF₆; LiCF₃SO₃, LiN(SO₂CF₃)₂, LiN(SO₂C₂F₅)₂ and LiC (organolithium salts such as SO₂CF₃)₃). Examples of the organic solvents include ethylene carbonate (EC), propylene carbonate (PC), butylene carbonate (BC), dimethyl carbonate (DMC), diethyl carbonate (DEC), and ethyl methyl carbonate (EMC). The supporting salt and the organic solvent in the organic electrolytic solution may be one kind or two or more kinds, respectively.

### 3. Electrolytic Solution

The ionic conductivity of the electrolytic solution is preferably high. The ionic conductivity at 25° C. is, for example, 0.1 mS/cm or higher. The ionic conductivity may be 1.0 mS/cm or higher, may be 3.0 mS/cm or higher, may be 5.0 mS/cm or higher, or may be 7.0 mS/cm or higher. On the other hand, the ionic conductivity at 25° C. is, for example, 15.0 mS/cm or less, and may be 10.0 mS/cm or less.

The electrolyte is used in a lithium-ion battery. The lithium-ion battery will be described later.

### B. Lithium-Ion Battery

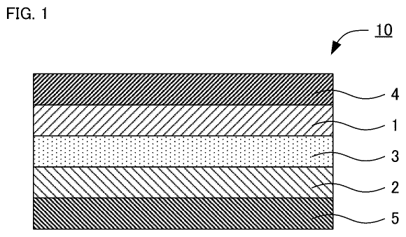

FIG. 1 is a schematic cross-sectional view illustrating a lithium-ion battery according to an embodiment of the present disclosure. The lithium-ion battery 10 shown in FIG. 1 has a cathode active material layer 1, a anode active material layer 2, and an electrolyte layer 3 disposed between cathode active material layer 1 and anode active material layer 2. The lithium-ion battery 10 includes a cathode current collector 4 that collects electrons of cathode active material layer 1 and an anode current collector 5 that collects electrons of anode active material layer 2. In particular, the lithium-ion battery 10 contains lithium-metal as anode active material. The lithium-ion battery 10 contains the above-described electrolyte solution. In the lithium-ion battery, it is preferable that all of anode active material layer, cathode active material layer, and the electrolyte layer contain the above-described electrolyte solution.

### 1. Anode Active Material Layer

Anode active material layer contains lithium-metal as anode active material. Here, the term “lithium metal” as used herein means a metal containing lithium. Therefore, the lithium metal includes a single substance of lithium, an alloy containing a lithium metal (lithium alloy), an oxide of a lithium metal, and an oxide of a lithium alloy.

Lithium-alloy include, for example, Li—Au, Li—Mg, Li—Sn, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te and Li—At. The lithium alloy may be one kind or two or more kinds.

Anode active material layer may contain at least one of an electrolyte, a conductive aid, and a binder. In particular, anode active material layers preferably contain the above-described electrolyte solution as an electrolyte. Examples of the conductive aid include a carbon material, metal particles, and a conductive polymer. Carbon materials include, for example, particulate carbon materials such as acetylene black (AB) and fibrous carbon materials such as carbon nanotubes (CNT). Examples of the binder include rubber-based binders such as butadiene rubber (BR) and fluorinecontain binders such as polyvinylidene fluoride (PVDF).

In addition, anode active material layer may be a layer formed by deposition of metallic lithium. That is, the lithium-ion battery in the present disclosure may be a battery using a precipitation-dissolution reaction of metallic lithium as a anode reaction. Although not shown in the drawings, a battery using a precipitation and dissolution reaction of metal lithium as a anode reaction includes, in this order, a anode current collector, a metal layer including a metal alloyable to lithium, an electrolyte layer, a cathode active material layer, and a cathode current collector. When such a battery is charged, the metal of the metal layer is alloyed with lithium, and an anode active material layer including lithium metal is formed. Examples of the metal capable of being alloyed with lithium include the metals described in the above-described lithium alloy.

### 2. Cathode Active Material Layer

Cathode active material layer contains at least cathode active material. Cathode active material layers preferably contain the above-described electrolyte solution.

Examples of the cathode active material may include an oxide active material. Examples of the oxide active material include rock salt layered active materials such as LiCoO₂, LiMnO₂, LiNiO₂, LiVO₂ and LiNi_{1/3}CO_{1/3}Mn_{1/3}O₂. Other exemplary oxide active materials include LiMn₂O₄, Li₄Ti₅O₁₂ and Li (spinel-type active materials such as Ni_{0.5}Mn_{1.5})O₄). Other exemplary oxide active materials include olivine-type active materials such as LiFePO₄, LiMnPO₄, LiNiPO₄ and LiCoPO₄.

In addition, cathode active material layers may contain at least one of an electrolyte, a conductive aid, and a binder. In particular, cathode active material layers preferably contain the above-described electrolyte solution as an electrolyte. Conductive assistants and binders are the same as described in “1. anode active material layers”.

### 3. Electrolyte Layer

The electrolyte layer is disposed between cathode active material layer and anode active material layer, and contains at least an electrolyte. The electrolyte layer preferably contains the above-described electrolyte solution as an electrolyte.

The electrolyte layer may be a layer in which the separator is impregnated with an electrolyte solution. The material of the separator may be an organic material or an inorganic material. Specific examples thereof include porous membranes such as polyethylene (PE), polypropylene (PP), cellulose, polyvinylidene fluoride, polyamide, and polyimide, nonwoven fabrics such as resinous nonwoven fabrics and glass-fiber nonwoven fabrics, and porous ceramic membranes. The separator may have a single-layer structure or a laminated structure.

### 4. Other Configurations

The lithium-ion battery in the present disclosure generally has cathode current collector and anode current collector. Examples of a material for the cathode current collector may include SUS, aluminum, nickel, iron, titanium and carbon. Meanwhile, examples of a material for the anode current collector may include SUS, copper, nickel and carbon.

Further, the lithium-ion battery according to the present disclosure may include a exterior body that accommodates the above-described member. Examples of exterior body include a laminate-type exterior body and a case-type exterior body.

### 5. Lithium-Ion Battery

The lithium-ion battery is typically a liquid-based battery. The lithium-ion battery may be a primary battery or a secondary battery, but is preferably a secondary battery. This is because it may be charged and discharged repeatedly, and it is useful, for example, as an in-vehicle battery.

The use of the lithium-ion battery in the present disclosure is not particularly limited, and examples thereof include a power supply of vehicles. Vehicles include, for example, hybrid vehicles (HEV), plug-in hybrid vehicles (PHEV), battery electric vehicle (BEV), gasoline vehicles, and diesel vehicles. In particular, the lithium-ion battery is preferably used as a power source for driving a hybrid vehicle (HEV), a plug-in hybrid vehicle (PHEV), or a battery electric vehicle (BEV). In addition, the lithium-ion battery may be used as a power source for a mobile object (for example, a railroad, a ship, and an airplane) other than vehicles. Further, battery in the present disclosure may be used as a power source of an electric device such as an information processing device.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Example 1

### Preparation of Electrolytic Solution

As an organic electrolyte, a DST3 manufactured by Mitsubishi Chemical Corporation was prepared. DST3 is an electrolyte solution obtained by adding a LiPF₆ of 1M to a mixed solvent of ethylene carbonate (EC), dimethyl carbonate (DMC), and ethyl methyl carbonate (EMC). LiCl and AlCl₄ were also weighed in a 1:1 molar ratio and mixed in a flask in an inert atmosphere. Liquid components were obtained by spraying the mixtures with SO₂ gases. The obtained liquid component was subjected to solid-liquid separation by filtration, and the liquid component was recovered as an inorganic electrolyte. The organic electrolytic solution and the inorganic electrolytic solution were weighed and mixed so as to have a weight ratio of 99.9:0.1. Thus, an electrolytic solution was prepared.

### Preparation of Measurement Cell

Lithium-metal was applied to both electrodes of a cube cell (SB-1A) made of EC Frontier, and the electrolyte solution was added to the inside. Thus, a measurement cell was prepared.

### Examples 2 to 5 and Comparative Examples 1 to 2

An electrolytic solution was prepared in the same manner as in Example 1, except that the organic electrolytic solution and the inorganic electrolytic solution were mixed at the ratios shown in Table 1, and a measurement cell was prepared.

### Evaluation

### Measure of Resistance Increase Rate

Each measurement cell was placed in a thermostat at 25° C. and homogenized. Thereafter, impedance measurement was performed at regular time intervals. The time course of the resistivity increase per one interface (interface resistance is equivalent to half) was acquired, and the resistivity increase rate was calculated from the slope. The results are shown in Table 1.

### Evaluation of Oxidation Resistance of Electrolyte

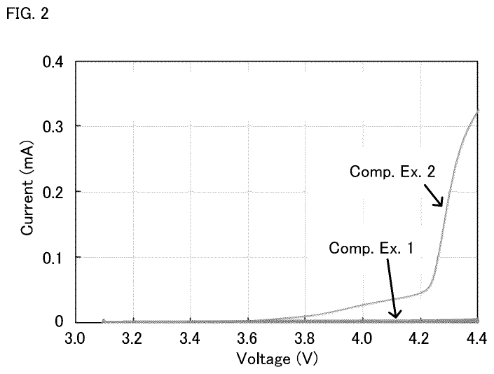

The oxidation resistance of the organic electrolytic solution and the inorganic electrolytic solution was evaluated using the measurement cells prepared in Comparative Examples 1 and 2. Specifically, it was evaluated from the behavior of the oxidation current when the potential was swept to the oxidation side. The results are shown in FIG. 2.

TABLE 1

| | composition of electrolytic solution | | |
|---|---|---|---|
| | organic | inorganic | |
| | electrolytic | electrolytic | resistance |
| | solution | solution | increase rate |
| | (wt %) | (wt %) | (Ω/h) |
| Comp. Ex. 1 | 100.0 | 0.0 | 335 |
| Example 1 | 99.9 | 0.1 | 311 |
| Example 2 | 95.0 | 5.0 | 20 |
| Example 3 | 90.0 | 10.0 | 3 |
| Example 4 | 80.0 | 20.0 | 1 |
| Example 5 | 60.0 | 40.0 | 1 |
| Comp. Ex. 2 | 0.0 | 100.0 | 2 |

As shown in Table 1, when an electrolytic solution containing an inorganic electrolytic solution was used, the resistance increase rate was remarkably suppressed. On the other hand, as shown in FIG. 2, it was confirmed that the inorganic electrolytic solution had a large current value on the oxidation side and had a lower chemical stability (oxidation resistance) than the organic electrolytic solution. This is considered to be due to the decomposition reaction of the lithium salt contained in the inorganic electrolytic solution. From this, it was confirmed that the electrolytic solution containing the organic electrolytic solution and the inorganic electrolytic solution has the merit (good oxidation resistance) of the organic electrolytic solution and can suppress the increased battery resistivity.

### REFERENCE SINGS LIST

1 cathode active material layer
2 anode active material layer
3 electrolyte layer
4 cathode current collector
5 anode current collector
10 lithium-ion battery

What is claimed is:

1. An electrolytic solution used in a lithium-ion battery, wherein
the lithium-ion battery contains a lithium metal as an anode active material,
the electrolytic solution contains an organic electrolytic solution and an inorganic electrolytic solution, and
the inorganic electrolytic solution contains a lithium salt and sulfur dioxide (SO₂).

2. The electrolytic solution according to claim 1, wherein the lithium salt contains at least one of AlCl₄⁻ and BCl₄⁻ as an anionic component.

3. The electrolytic solution according to claim 1, wherein a ratio of the inorganic electrolytic solution to a total of the organic electrolytic solution and the inorganic electrolytic solution is 0.05% by weight or more and 70.0% by weight or less.

4. The electrolytic solution according to claim 1, wherein a ratio of the inorganic electrolytic solution to a total of the organic electrolytic solution and the inorganic electrolytic solution is 0.10% by weight or more and 40.0% by weight or less.

5. A lithium-ion battery using a lithium metal as an anode active material, wherein the lithium-ion battery contains the electrolytic solution according to claim 1.
